(19) United States
(12) Patent Application Publication
(10) Pub. No.: US 2008/0040222 A1
(43) Pub. Date: Feb. 14, 2008

(54) APPARATUS, NETWORK AND METHOD FOR PERFORMING COMMERCIAL TRANSACTIONS

(75) Inventor: Craig Gee, Sydney (AU)

Correspondence Address: BLAKELY SOKOLOFF TAYLOR & ZAFMAN, 1279 OAKMEAD PARKWAY, SUNNYVALE, CA, 94085-4040, US

(73) Assignee: Mining & Construction Card Company Pty. Ltd., Sydney (AU)

(21) Appl. No.: 11/836,111

(22) Filed: Aug. 8, 2007

(30) Foreign Application Priority Data
Aug. 9, 2006 (AU) 2006904329

(51) Int. Cl. G06Q 30/00; G06Q 10/00

(52) U.S. Cl. 705/14; 705/39

(57) ABSTRACT

A method of administering an incentive award system is provided, together with apparatus for use in the administration of an incentive award system. The method includes allocating a plurality of merchants into one or more of a plurality of different merchant categories, providing an identifier to a participant and establishing an award account for the participant, the award account comprising an account category associated with each of the merchant categories. Commercial transactions made by the participant at any one of the merchants are monitored, and an award amount is allocated to the account of the participant, the allocation being dependent on the monitored commercial transactions and comprising an allocation of an amount to a plurality of the account categories. Awards allocated to the account of the participant represent awards that are redeemable by the participant for value.

### FIELD OF THE INVENTION

The present invention generally relates to methods and apparatus for performing commercial transactions. In particular, the present invention relates to the provision of an incentive award system or loyalty program for commercial transactions.

### BACKGROUND OF THE INVENTION

Incentive award systems, often implemented in the form of loyalty programs, have become a widespread and common way for merchants operating in the retail space to encourage continued and repeat business from customers. Typically, loyalty programs involve the issuance of a card to a customer, which the customer presents when making a purchase at a retail merchant. Loyalty points, which may be calculated depending on the amount spent at the merchant, are credited to a loyalty account of the purchaser. The purchaser is then given the option of redeeming the loyalty points for specified goods or services.

Some retailers have offered private label cards to their customers to further encourage increased sales and repeat business. The retailer thereby obtains the advantage of their customers having a specific transaction card for purchases at their business and the advantage of being able to charge for extending credit to their customers, receiving some of the revenue that may otherwise be received by retail banks or other financial institutions.

However, there remains significant commercial transactions where incentive reward systems are not provided, but where an incentive reward system could still provide advantage. The lack of an incentive reward system covering such transactions may be due to the absence of a suitable system for the participants to the transactions.

A limitation in many existing loyalty programs is that the customers do not always want the rewards that are offered.

It is an object of the present invention to provide an incentive awards system that operates in an alternative way to known incentive award systems and which may therefore provide additional or different advantages over existing incentive award systems. It is a further or alternative object of the present invention to at least provide at least one apparatus, method and/or network that may be used to provide a useful alternative incentive award system.

### SUMMARY OF THE INVENTION

According to a first aspect, the invention broadly resides in a method of administering an incentive award system, the method comprising:
allocating a plurality of merchants into a plurality of merchant categories;
providing an identifier to a participant;
monitoring commercial transactions made by the participant at any one of the merchants;
allocating an award amount to an account of the participant, the allocation being dependent on the monitored commercial transactions and comprising an allocation of an amount to a plurality of account categories.

Preferably, the method further comprises allowing a participant to redeem the award allocated to at least one of the account categories only with a merchant allocated to one or more designated merchant categories, the number of designated merchant categories being less than the total number of merchant categories.

Preferably, a single merchant is allocated to each merchant category.

Preferably, at least one of the account categories is a general account category and the method comprises allowing a participant to redeem any award allocated to the general account category at any of the plurality of merchants.

Preferably, the method further comprises allocating the award amount to the account of the participant in a plurality of classes, wherein awards allocated to at least one class can only be redeemed following the occurrence of a predefined event. The predefined event may be the elapsing of a certain time period for that class and different classes may have different time periods.

Preferably, the method further comprises transferring awards from one category to another category if the participant satisfies predetermined requirements. The predetermined requirements may be the tender of a statement from the participant that they have not purchased any goods or services offered by the merchant allocated to the category from a competitor of that merchant.

Preferably, the method comprises generating a periodic statement to each participant, the statement detailing the awards and/or rewards available in each category. Preferably, where a plurality of classes are provided, the statement also breaks down the awards or rewards into each class.

Preferably, the method comprises providing identifiers to a plurality of participants, monitoring each participant's commercial transactions and allocating an award amount to a plurality of account categories in an account of each participant.

Preferably, the method is implemented by, or with the aid of a computer.

According to a second aspect, the invention broadly resides in a method of administering an incentive award system, the method comprising using a computational controller to provide in computer readable memory:
a definition of a plurality of merchant categories, each merchant category associated with at least one merchant identifier, and
a definition of a plurality of participant identifiers, each participant identifier associated with a participant account defined in the computer readable memory so as to comprise, or be able to comprise, a plurality of account categories; the method further comprising:
receiving at the computational controller transaction information defining a said participant identifier and details of a commercial transaction;
in response to the receipt of the transaction information, using the computational controller to provide in the computer memory a definition of an award amount in each of a plurality of said account categories in the participant account associated with the participant identifier defined by the received information;
   wherein at least one of the account categories is defined in the computer memory so as to be associated with at least one, but less than all, of the merchant categories.

Preferably, at least one of the merchant categories is associated with a single merchant identifier. The definition of a merchant category associated with a single merchant identifier may consist of its associated merchant identifier.

In one embodiment, the method further comprises receiving at the computational controller further transaction information defining a said merchant identifier, a said participant identifier and award redemption information, and in response thereto identifying the merchant category associated with the merchant identifier defined in the further transaction information, identifying the participant account associated with the participant identifier defined in the further transaction information, and defining a reduced award amount according to the award redemption in an account category in the identified participant account, said account category being an account category associated with the identified merchant category.

In another embodiment, the method further comprises receiving at the computational controller further transaction information defining a said merchant category, a said participant identifier and an award redemption, and in response thereto identifying the participant account associated with the participant identifier defined in the further transaction information, and defining a reduced award amount according to the award redemption in an account category in the identified participant account, said account category being an account category associated with the merchant category defined by the further transaction information.

Preferably, the method further comprises the computational controller defining at least one said account category so as to be associated with all of the merchant categories.

Preferably, the method further comprises defining for at least one account category a plurality of classes and allocating the award amount for that account category between the plurality of classes.

Preferably, the method further comprises only allowing an award redemption in one said class of an account category, and the method further comprises transferring award amounts allocated to another class to that class upon the occurrence of a predefined event. Preferably, the predefined event is the elapsing of certain date.

Preferably, the method further comprises transferring awards from one account category to another account category.

According to a third aspect, the invention broadly resides in computer apparatus comprising a computational controller and a computer memory readable by the computational controller, the computer memory storing instructions executable by the computational controller to perform the method described in the preceding paragraphs.

Preferably, the computer apparatus further comprises further computer memory storing data able to be read and updated by the computational controller, the data comprising the definition of the merchant categories and associated one or more merchant identifiers, the definition of the participant identifiers and their associated participant accounts, and the definition of the award amounts.

The computer apparatus preferably includes a communication interface with a wide area network, wherein the transaction information and/or further transaction information is received by the communications interface from the wide area network and communicated to the computational controller.

According to a fourth aspect, the invention broadly resides in a computer network comprising the computational controller described in the preceding paragraphs, and a plurality of merchant terminals, each merchant terminal arranged to send the transaction information and further transaction information to the computational controller over the computer network.

Further aspects of the present invention will become apparent from the following description, given by way of example only and with reference to the accompanying drawings.

### BRIEF DESCRIPTION OF THE DRAWINGS

FIG. 1 shows a commercial transaction network according to an embodiment of an incentive award system of the present invention.

FIG. 2 shows details of database records that may be maintained in the database from the commercial transaction network shown in FIG. 1.

FIG. 3 shows a process performed in accordance with a method of providing or administering an incentive reward system according to an embodiment of the present invention.

FIG. 4 shows an exemplary statement for a participant of an incentive rewards system of the present invention.

### DETAILED DESCRIPTION

The present invention generally relates to apparatus and methods for performing commercial transactions, particularly apparatus and methods for maintaining an incentive reward system relating to commercial transactions. The present invention may have particular application to business to business transactions.

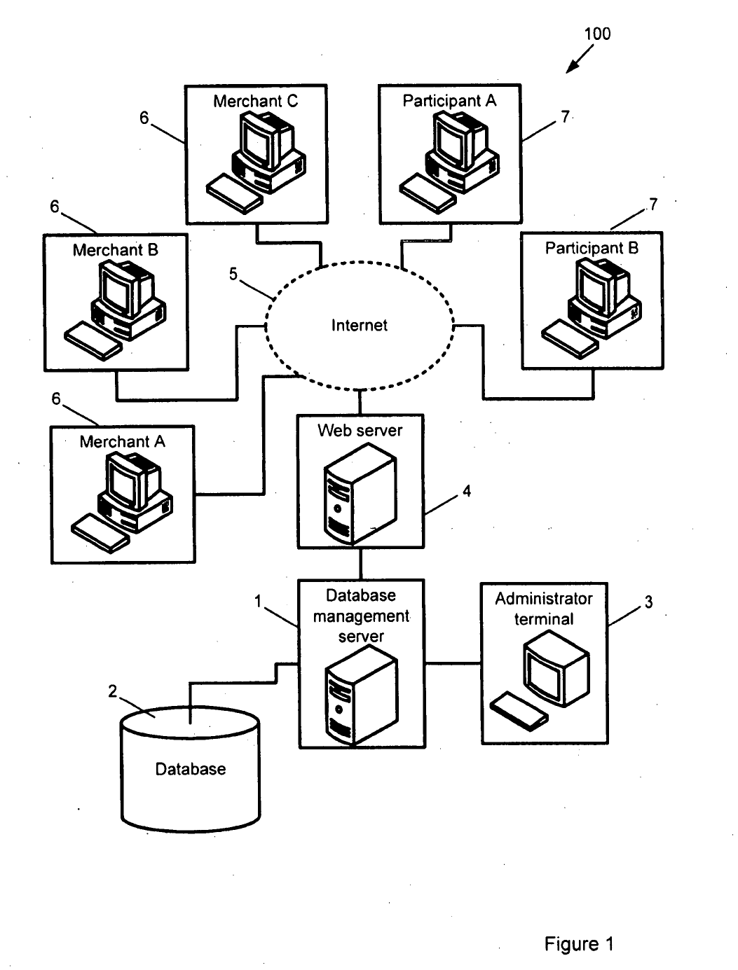

FIG. 1 shows a diagrammatic representation of a commercial transactions network 100 for implementing the present invention. The transaction network 100 includes a database management server 1 with an associated database 2. The database management server 1 further includes memory (not shown) containing instructions that when executed by the database management server cause the database management server 1 to implement aspects of the present invention.

An administrator terminal 3 may allow an operator of the database management server to maintain the database 2 and configure and update the operation of the database management server 1 and a web server 4. The web server 4 provides access to the database management server 1 through a wide area network, for example the internet 5. The web server 4 establishes one or more web pages accessible through the internet 5, the web pages allowing entry and retrieval of information to and from the database 2 via the database management server 1.

The database management server 1, database 2, administrator terminal 3 and optionally the web server 4 comprise part of a corporate network. Those skilled in the relevant arts will appreciate that many alternative structures may be provided, the structure shown in FIG. 1 being a simplified representation of an exemplary structure provided for the purposes of explanation of the present invention.

Also connected to the internet 5 are merchants 6 and participants 7. Each merchant 6 and participant 7 may connect to the internet 5 through a computer terminal and access the web server 4 and view the web pages provided by the web server 4 using a suitable browser application. For illustrative purposes only three merchants 6 and two participants 7 are represented in FIG. 1, although in reality there may be one, two or four or more merchants 6 and one or three or more participants 7. In addition, a single entity may be both a merchant 6 and a participant 7.

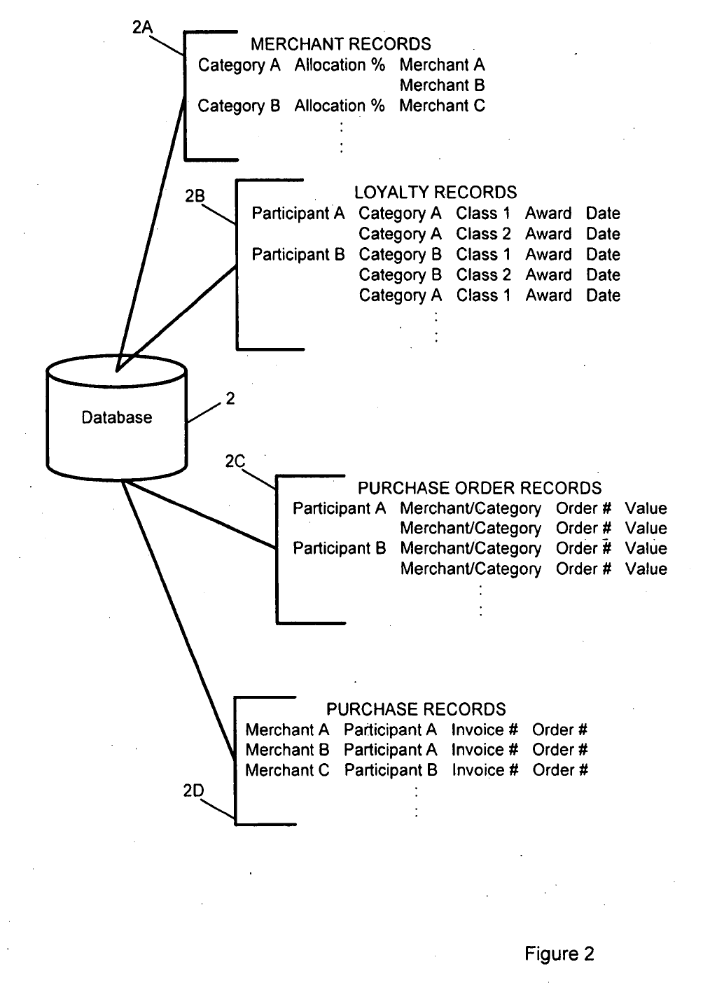

FIG. 2 shows the database 2 and exemplary database records 2A-2D. Those skilled in the relevant arts will appreciate that the specific structure of the database 2 may be varied. It is anticipated that the database 2 may be implemented as a relational database.

The merchant records 2A contains identifiers of a plurality of categories and the identifiers of the merchants 6 involved in the incentive reward system. A merchant may be a supplier of goods or services. Each merchant is allocated to a category and the merchant identifier is associated with the category definition in the database 2. In addition, each merchant category is allocated an allocation percentage that, as explained in more detail herein below, determines the allocation of awards to the merchants in that category. Alternatively, where each merchant category is to receive an equal allocation of awards, the allocation percentage may be omitted.

In the exemplary representation of merchant records 2A shown in FIG. 2, two merchant categories, category A and category B are shown, with Merchant A and Merchant B allocated to category A and Merchant C allocated to category B. The categories may be defined by the goods or services that the merchant offers. It may be advantageous, in a single incentive reward system, to only have a single merchant allocated to each category. Alternatively, if more than one merchant is allocated to a category, a check may be made that the merchants are not direct competitors. Where a category is allocated to only a single merchant, the merchant identifier and category identifier may be one and the same (and therefore the category identifier and merchant identifier are automatically and inherently associated with each other).

The loyalty records 2B contain a listing of each participant 7 and their associated award(s). A participant 7 is a potential purchaser of products or services from a merchant 6. For each participant, multiple entries are maintained, one for each account category and class. The account categories may match the merchant categories entered in the merchant records 2A. However, in alternative embodiments, a single account category may include multiple merchant categories, but not all merchant categories unless it is a general account, so as to allow redemption at a wider range of merchants 7. Individual participants 6 may therefore have individual account categories that cover different merchants 7.

The class within an account category dictates the type of award that has been awarded as part of the incentive reward system. In addition, the loyalty records may contain date entries relating to when the award was awarded, which as explained herein below may be used when the classes define delay periods before an award can be redeemed, but may also be used for other purposes, such as setting an expiration date for awards.

As explained in more detail herein below, the different classes may be used to specify when awards become redeemable. When the criteria for an award to become redeemable takes into account the time elapsed since the award was earned, then the date information is used to monitor when the award becomes redeemable. If other criteria are used, then the date information may be omitted, replaced with other information of relevance to the criteria if required. Where there is only a single class, then the class definitions may be omitted from the loyalty records 2B.

The database 2 may also contain purchase order records 2C. When a participant 7 wishes to authorise a purchase at a merchant 6, the participant 7 can, in advance enter into the database 2 a purchase order, identifying either the merchant 6 or the merchant category, providing an order number and optionally also assigning the purchase order a value or range of values. This information may be used to authorise a commercial transaction at a merchant 6 before it is processed.

The database 2 may also contain purchase records 2D, identifying each purchase made by each participant 7 at a merchant 6, and recording the invoice number of the Invoice that the merchant 6 used for the purchase and the purchase order number of the participant 7 that was applicable to the transaction. Additional information may be contained in the purchase records 2D, for example the date of the purchase, amount of the transaction, which may be displayed as both the amount including and excluding any applicable taxes, and/or a listing of the goods or services supplied.

The database 2 may contain database records 2A-2D for a plurality of incentive reward systems, each of which are maintained by the database management server 1. The web server 4 may provide different web pages for each incentive rewards system, which may be located a the same or different addresses.

Information in the database 2 may be complied into reports for the merchants 6, participants 7 and the administrator of the incentive reward system. Each merchant 6 and participant 7 may, for example be allocated a password and the database management server 1 programmed so that they can only access records and generate reports containing information relevant to their transactions.

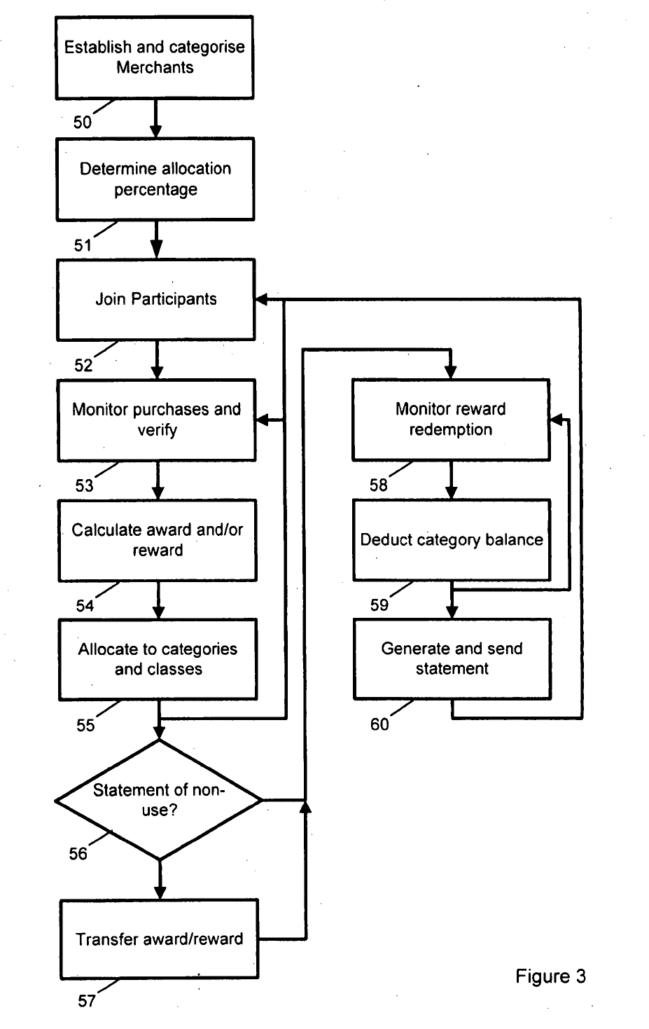

FIG. 3 shows a flow diagram of an exemplary process that may be performed by the transaction network 100, in particular by the database management server 1 in cooperation with the database 2. Much of the information communicated for each step may be communicated to the database management server 1 using a terminal at the premises of the merchant 6 or participant 7 and the web server 4, which passes data to the database management server 1. In particular, the presently contemplated most preferred embodiment of the present invention involves the incentive reward system operating by merchants 6 entering details relating to purchases and redemption of awards into one or more web pages provided by the web server 4. The merchants 6 may also be able to telephone, email or otherwise contact the administrator of the incentive reward system and provide details for a transaction, receive authorisation for the transaction and to redeem awards. An alternative mode of communication may be used if communication with the web server 4 became unavailable for some reason.

Steps 50-52 involve setting up a reward incentive system. Step 50 is the establishment of the merchants 6, or the addition of a new merchant 6. When a merchant is established, an entry is made in the merchant records 2D in a particular category. A single merchant 6 may be associated with more than category, and in this case there may be only a single merchant 6 in the incentive reward system. In this case, the merchant categories may specify different product types or ranges offered by the merchant, specify different departments within the merchant, or otherwise separate the activities of the merchant, in which case the single merchant is effectively treated as a plurality of merchants. However, in the preferred embodiment as presently contemplated there are a plurality of non-competing merchants and each merchant 6 is allocated to a single category.

Each merchant category is then allocated an allocation percentage (step 51). This allocation percentage determines the percentage of the awards generated by a commercial transaction by a participant 7 that is allocated to that merchant category. When a participant 7 makes a purchase at a merchant 6, for example merchant A, the award that results from that purchase is split between a plurality of the merchant categories in the incentive reward system. The award is preferably split between all of the merchants categories in that particular incentive reward system.

For example, category A may receive 30% of the award allocation, category B may receive 25% of the award allocation and a third category, category C, may receive 25% of the award allocation. The remaining 20% may be allocated to a general award account for the participant 7. The percentage allocations may be determined by any appropriate method, for example having regard to the dollar value of purchases that are likely to be made by participants 7 at the merchant(s) 6 in that category in comparison to the dollar value of purchases made in the other categories. The allocation percentage could be determined at least in part with reference to historical purchase activity. For example, the awards may be allocated in batches on a monthly basis based on the purchases made in that month.

In step 52, participants 7 are entered into the database 2 with an allocated participant identifier. The participants 7 are also issued with an identifier that they can use at a merchant 6 to identify themselves as a participant 7. This identifier is conveniently the same identifier entered into the database 2, although a transformation of identifiers could occur if required, for example by using a look-up table stored either at the premises of the merchant 6, in the database 2, or elsewhere.

The participant identifier allows a transaction at a merchant 6 to be identified as a transaction of that particular participant 7, so that the awards that arise from the transaction can be allocated to the participant 7. The participant identifiers may be stored in the database 2 and may represent a code word, number or other information. The participant 7 may, for example, provide the identifier in a magnetic swipe card, smart card, by saying or typing in the identifier and/or through use of biometric information.

After the merchants 6 and participants 7 have been identified and recorded, the purchases made by participants 7 at the merchants 6 are monitored (step 52). This may be achieved in a number of different ways, including by maintenance of paper records, which are then reviewed and entered at the administrator terminal 3 or at a terminal of a merchant 6, and by monitoring electronic transactions through funds transactions networks. However, the currently contemplated preferred embodiment involves the merchant 6 accessing a webpage provided by the web server 4 and entering details of the purchase into the webpage. The web server 4 then receives the entered information and passes it onto the database management server 1 for entry into the database 2.

In addition, where the participants 7 have provided purchase order numbers for the purchase order records 2C, the merchant 6 enters the purchase order number into a webpage and the database management server 1 returns an indication to the terminal of the merchant 6 as to whether the number matches a purchase order number stored in the database 2. The merchant 6 can also obtain confirmation that the actual purchase corresponds to any approved value or value range in the purchase order records 2C.

The merchant 6 may also be provided at their terminal, in response to inputting the participant identifier, with notification of the awards that have been awarded to the participant in the merchant category that the merchant 6 has been allocated to. This allows the merchant 6 to confirm what part of payment for goods or services can be made from awards and what portion, if any, will still need to be made by the participant 7. The merchant 6 can then offer to use some or all of the available awards for the purchase.

Either for each purchase or as a batch process combining multiple purchases, the award allocated to a participant 7 based on their purchases is calculated (step 54). In one embodiment step 54 may involve calculating an award in the form of a monetary reward as a percentage of all purchases made by a participant 7, regardless of which merchant 6 in the incentive reward system the purchase was made at. Alternatively, purchases at different merchants 6 may have separate formulae for calculating the resultant award. The calculation may determine an award (eg a number of loyalty points) that can be combined with other awards and traded in for a reward at a later date.

Once the award or reward has been calculated, it is then allocated to a number of account categories. As explained previously herein, an account category may be associated with a single merchant category containing one or a plurality of merchants 6, or may be associated with a plurality of merchant categories, each associated with one or a plurality of merchants 6. The allocation is then entered into the loyalty records 2B of the database 2 (step 55). In addition, step 55 involves allocating the awards to different classes. The classes dictate when the award/reward can be redeemed. For example, one class may allow immediate redemption, while another class might only allow redemption following the occurrence of a predetermined event. This event may be time based, for example, the expiration of 3 months, which may be measured from the date of the purchase. Other classes may have longer waiting periods.

Alternative events may also trigger an award to become redeemable, for example, the participant making a certain amount of purchases, or making a purchase at merchants 6 in a certain proportion of the merchant categories, for example every category. Alternatively, all the award or reward for a category may be allocated to a single class, which may be awards available for redemption immediately.

The process comprises continually monitoring purchases and allocating awards to each category and class for all participants and any new participants to the loyalty program. When a new merchant category is created, then the percentage allocation to all of the merchant categories is varied to maintain a total of 100% allocation. This may temporarily change, for example during a promotion, in which case there may be more than 100% allocation of the normal amount of awards from a purchase due to one or more merchant categories offering increased incentive awards for making a purchase at that time.

A participant 7 may not require any purchases from a merchant 6 in a particular category. In this case, the awards allocated to that category may be of little or no benefit to that participant 7. This will reduce the value of the incentive reward system to the participant 7. To avoid this situation, an option may be provided for the participant 7 to provide a statement that they do not use a particular category. This statement may be provided when they join, or maybe provided later, for example by entering information onto a web page provided by the web server 4.

Certain minimum requirements for the statement may be set by the provider of the loyalty program. For example that the statement of non-use must be applicable for all time, or applicable for a particular period of time, for example a period of three months.

The process therefore includes a step of determining whether a statement of non-use has been received (step 56). When a statement of non-use is received, the participant 7 can transfer the award from the merchant category that is not used to another merchant category (step 57). This other category may be nominated by the participant 7 and/or where one is provided, the award may be transferred to a general category, allowing the participant to use the award at any merchant that agrees to redeem general awards and rewards. The award may optionally be discounted if it is transferred to a general category.

If a general category is provided, an option may be given to some merchants 6 to opt of this option, so that awards in the general category can not be redeemed at that merchant 6.

In step 58 the redemption of rewards is monitored. Again, this may be achieved in any one of a number of different ways, but the presently contemplated preferred embodiment involves a merchant 6 entering details of the redemption using their terminal and communicating this information to the database management server 1 via the internet 5 and web server 4. The database management server 1 then deducts the category balance for that participant (step 59). The details of the redemption may be the merchant identifier, participant identifier and information identifying the amount of awards to be redeemed.

Periodic statements may be generated and sent by the incentive reward system provider to each participant 7 (step 60). The statement may be generated by the program provider by operating the administrator terminal 3, with the database management server 1 extracting the relevant records from the database 2. The statements may be sent electronically to the participants via the internet 5, or downloaded by each participant 7 and merchant 6 from the web server 4, preferably using a secure connection.

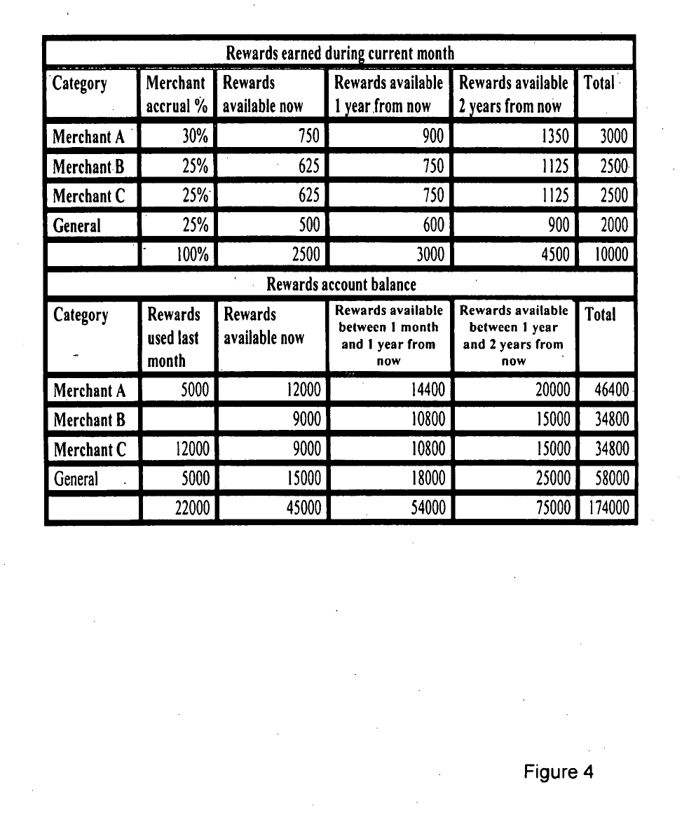

FIG. 4 shows an exemplary form of the statement, where the awards of the incentive reward system are monetary rewards. The statement shows the rewards allocated to each category, with the example shown in FIG. 4 having only one merchant per category and a general category. The statement also specifies when the rewards are available, which depends on what class the awards were allocated to and the time that has elapsed. As an example, the classes are rewards available now, rewards available in one year and rewards available in two years. If a monetary class eligibility trigger was used, the statement may indicate that some rewards are available now, while others will be available following a certain additional amount of spending at a merchant 6.

In the rewards account balance, the statement may include details of what rewards have been redeemed during the last statement period, the rewards available now and the rewards available in particular time periods.

Where in the foregoing description reference has been made to particular integers or components having known equivalents, then those equivalents are hereby incorporated herein as if individually set forth.

Those skilled in the relevant art will appreciate that modifications and additions may be made to the present invention described herein without departing from the scope of the invention. It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is used in an inclusive sense, not an exclusive or exhaustive sense, and as such should not be taken as excluding the presence of other elements or features.

What is claimed:

1. A method of administering an incentive award system, the method comprising:
allocating a plurality of merchants into one or more of at least three different merchant categories;
providing an identifier to a participant and establishing an award account for the participant, the award account comprising distinct account categories associated with each of the merchant categories;
monitoring commercial transactions made by the participant at any one of the merchants;
for one of the monitored commercial transactions, allocating an award amount to the account of the participant, the allocation being dependent on the monitored commercial transaction and comprising an allocation of an amount to a plurality of the account categories, at least one of the account categories being a category that is not associated with the merchant at which the participant made that monitored commercial transaction; and
repeating the process of allocating an award amount to the account of the participant for each of the monitored commercial transactions;
wherein awards allocated to the account of the participant represent awards that are redeemable by the participant for value.

2. The method of claim 1 further comprising allowing the participant to redeem the award allocated to at least one of the account categories only in relation to transactions with a merchant allocated to that merchant category.

3. The method of claim 1, wherein a single merchant is allocated to each merchant category.

4. The method of claim 2, further comprising establishing the award account to include a general account category, allocating awards to the general account category, and allowing a participant to redeem any award allocated to the general account category at the plurality of merchants without regard to which merchant category those merchants have been allocated.

5. The method of claim 1, further comprising establishing a plurality of account classes within each account category associated with a merchant category and allocating the award amount to the account of the participant in a plurality of classes, wherein awards allocated to at least one class can only be redeemed following the occurrence of a predefined event.

6. The method of claim 5, wherein the predefined event is the elapsing of a certain time period for that class and wherein different classes have different time periods.

7. The method of claim 1, further comprising transferring awards from one account category to another account category if the participant satisfies predetermined requirements.

8. The method of claim 7, wherein the predetermined requirements comprise the tender of a statement from the participant that they have not purchased any goods or services offered by the merchant allocated to the category from a competitor of that merchant.

9. The method of claim 1, further comprising generating a periodic statement to each participant, the statement detailing the awards and/or rewards available in each category.

10. A method of administering an incentive award system, the method comprising using a computational controller to provide in computer readable memory:
a definition of at least three merchant categories, each merchant category associated with at least one merchant identifier, and
a definition of a plurality of participant identifiers, each participant identifier associated with a participant account defined in the computer readable memory, the participant account comprising a plurality of account categories corresponding to the merchant categories;
the method further comprising:
receiving at the computational controller transaction information relating to a transaction between a said participant and a said merchant, the transaction information defining the participant identifier of that participant and details of a commercial transaction;
in response to the receipt of the transaction information, using the computational controller to provide in the computer memory a definition of an award amount in each of a plurality of said account categories in the participant account associated with the participant identifier, at least one of the account categories not being associated with the merchant at which the transaction that the transaction information relates to was performed;
wherein at least one of the account categories is defined in the computer memory so as to be associated with at least one, but less than all, of the merchant categories.

11. The method of claim 10, further comprising defining for at least one account category a plurality of classes and allocating the award amount for that account category between the plurality of classes.

12. The method of claim 11, further comprising only allowing an award redemption in one said class of an account category, and wherein the method further comprises transferring award amounts allocated to another class to that class upon the occurrence of a predefined event.

13. The method of claim 12, wherein the predefined event is the elapsing of certain date.

14. The method of claim 10, further comprising receiving at the computational controller further transaction information defining a said merchant identifier, a said participant identifier and award redemption information, and in response thereto identifying the merchant category associated with the merchant identifier defined in the further transaction information, identifying the participant account associated with the participant identifier defined in the further transaction information, and defining a reduced award amount according to the award redemption in an account category in the identified participant account, said account category being an account category associated with the identified merchant category.

15. The method of claim 10, further comprising receiving at the computational controller further transaction information defining a said merchant category, a said participant identifier and an award redemption, and in response thereto identifying the participant account associated with the participant identifier defined in the further transaction information, and defining a reduced award amount according to the award redemption in an account category in the identified participant account, said account category being an account category associated with the merchant category defined by the further transaction information.

16. Computer apparatus comprising a computational controller and a computer memory readable by the computational controller, the computer memory storing instructions executable by the computational controller to perform the method of claim 1.

17. The computer apparatus of claim 16, further comprising further computer memory storing data able to be read and updated by the computational controller, the data comprising the definition of the merchant categories and associated one or more merchant identifiers, the definition of the participant identifiers and their associated participant accounts, and the definition of the award amounts.

18. The computer apparatus of claim 17, comprising a communication interface with a wide area network, wherein the transaction information and/or further transaction information is received by the communications interface from the wide area network and communicated to the computational controller.

19. A computer network comprising the computational apparatus of claim 16, and a plurality of merchant terminals, each merchant terminal arranged to send the transaction information and further transaction information to the computational controller over the computer network.

20. A method of administering an incentive award system, the method comprising:
allocating a plurality of merchants into one or more of a plurality of different merchant categories;
providing an identifier to a plurality of participants and establishing an award account for each participant, the award account comprising a distinct account category associated with each of the merchant categories;
monitoring commercial transactions made by the participants at any one of the merchants over a time period;
determining a relative value of transactions made in each of the merchant categories over the time period;
for each transaction determined as occurring during the time period as a result of the process of monitoring commercial transactions, allocating an award amount to the account of the participant, the total allocation being dependent on the monitored commercial transaction and the allocation between the account categories being dependent on the determined relative value of the transactions, wherein awards allocated to the account of a said participant represent awards that are redeemable by that participant for value.

21. The method of claim 20, including repeating the monitoring, determining and allocation steps for a plurality of consecutive time periods, wherein for each time period, there is a different relative value of transactions made in each of the merchant categories.

22. The method of claim 20, wherein the allocation to a said account category is proportional to the determined relative value of the commercial transactions for that account category.

23. The method of claim 20, further comprising establishing a plurality of account classes within each account category associated with a merchant category and allocating the award amount to the account of the participant in a plurality of classes, wherein awards allocated to at least one class can only be redeemed following the occurrence of a predefined event.

24. The method of claim 23, wherein the predefined event is the elapsing of a certain time period for that class and wherein different classes have different time periods.
